(19) United States
(12) Patent Application Publication
(10) Pub. No.: US 2003/0101457 A1
(43) Pub. Date: May 29, 2003

(54) Systems and methods for distributing, duplicating and viewing movies, including customer-specific identification in the title sequence thereof

(76) Inventor: Michael D. Tiemann, Chapel Hill, NC (US)

Correspondence Address: MYERS BIGEL SIBLEY & SAJOVEC, PO BOX 37428, RALEIGH, NC, 27627, US

(21) Appl. No.: 09/995,023

(22) Filed: Nov. 26, 2001

(51) Int. Cl. G06F 3/00; H04N 5/445; G06F 13/00; H04N 7/173

(52) U.S. Cl. 725/61; 725/87; 725/105; 725/40; 348/563

(57) ABSTRACT

An order for a movie is received from a customer, and a customer-specific identification is inserted into a title sequence for the movie that identifies actors, directors and/or producers of the movie. The movie, including the customer-specific identification in the title sequence, then is provided to the customer or a designee of a customer. Thus, the name of a customer or a designee of the customer is integrated into the title sequence, along with actors, directors and/or producers of the movie.

### FIELD OF THE INVENTION

This invention relates to the distribution, duplication and viewing of media, and more particularly to the distribution, duplicating and viewing of movies.

### BACKGROUND OF THE INVENTION

Motion pictures or movies are a widely distributed form of entertainment. The movie production industry includes actors, directors, writers, producers and many other contributors who cooperatively complete a movie. The movie distribution industry places the finished movie before the viewing public through a variety of distribution channels, generally for a fee.

The movie distribution industry generally reaches beyond movie theaters. While a good box office gross generally is a desirable outcome for a movie distributor, movies shown in theaters can often earn additional revenue when licensed for pay-per-view, premium cable, video sales and/or rental, basic cable, and even basic television broadcast. Each of these distribution channels can provide substantial revenue opportunities. It, therefore, may be desirable to maximize the revenue potential of each distribution channel.

Each of these distribution channels may command a premium value, i.e. a value that viewers will pay to see the movie when delivered via the distribution channel. Viewers generally pay the highest premium to see a movie in a theater. The next highest premium generally is pay-per-view. As is well known, pay-per-view allows a customer to order a movie, and then to receive the movie at a predetermined time or immediately (often referred to as “on-demand” movies). Pay-per-view movies often are ordered and received via a cable television system, a satellite television system and/or an Internet distribution system. On-demand movies often are ordered and viewed in hotel rooms.

After pay-per-view, the next highest premium generally is obtained by videotape and/or DVD rental in video rental stores. The next highest premium generally is obtained by premium cable channels, where the premium is shared across all movies offered via that premium channel. The next highest premium generally is obtained by basic cable. Finally, the lowest premium generally is obtained by “free” television, where viewers do not pay, but advertisers pay to offer free programming interspersed with advertising.

Each of the distribution channels described above generally commands a different premium. Moreover, viewers generally tend to be unwilling to pay a higher premium for goods delivered later rather than earlier. Accordingly, content owners generally make content available first at the highest premium, and then discount the content until each market has paid the premium that it is willing to pay. When a movie is in a distribution channel and earning revenue from that channel, the channel is referred to as a “window”. Distributors generally desire to maximize the value of these windows by commanding the highest premiums they can and/or collecting these premiums from the largest number of viewers they can.

Consumer polls have suggested that the pay-per-view window should be the most lucrative window for most movies. Moreover, the entertainment industry traditionally has expected the pay-per-view window to be the most lucrative window for many movies. However, pay-per-view generally has been less lucrative than consumer polls and industry expectations have predicted. In particular, experience has shown that many viewers are unwilling to actually pay the pay-per-view premium that they agree is fair and reasonable. Instead, many viewers wait to receive such content at a lower premium, in a later window. Thus, the earning potential of pay-per-view may not be met. Moreover, since the value of the movie degrades over successive windows, revenues that are not earned in the pay-per-view window may not be recovered.

### SUMMARY OF THE INVENTION

Embodiments of the invention provide systems and methods for distributing movies wherein an order for a movie is received from a customer, and a customer-specific identification is inserted into a title sequence for the movie that identifies actors, directors and/or producers of the movie. The movie, including the customer-specific identification in the title sequence, then is provided to the customer or a designee of a customer. These embodiments of the invention may stem from a realization that recognition, in the form of a movie title credit, is highly valued by the actors, directors, producers and/or others who are credited. In fact, title credit recognition often is a material consideration offered to secure a party's participation in the development, production and/or distribution of a movie. Embodiments of the invention integrate the name of a customer or a designee of the customer into the title sequence, along with actors, directors and/or producers of the movie. The customer is thus provided with recognition and ego gratification, thereby allowing distributors to monetize the customer's desire for prestige. An increase in a premium that may be commanded by pay-per-view or other distribution channels thereby may be obtained.

Embodiments of the invention may receive an order for the movie and may provide the movie including the customer-specific identification in the title sequence over a cable television system, a satellite television system and/or the Internet. Thus, many movie distribution channels may benefit from embodiments of the invention.

Moreover, it is well known to those having skill in the art that title sequences for movies now are generally generated using digital title sequence software. Accordingly, embodiments of the invention can digitally insert the customer-specific identification into the digital title sequence. A high-quality insertion of the customer-specific identification can seamlessly be provided in a title sequence, to provide recognition and/or ego gratification for the customer.

Many embodiments of customer-specific identification may be provided in the title sequence. In some embodiments, the title sequence includes a sequential listing of names of actors, directors and/or producers of the movie and the customer-specific identification comprises the name of the customer in the sequential listing of names of actors, directors and/or producers of the movie. In other embodiments, the customer-specific identification comprises the words “screened by” followed by the name of the customer. In other embodiments, the customer-specific identification comprises the words “brought to you by” followed by the name of the customer. In other embodiments, the customer-specific identification comprises the words “screened for” followed by the name of a designee of the customer followed by the word “by” followed by the name of the customer. Many other embodiments of customer-specific identification may be provided.

Embodiments of the invention also may provide for duplicating movies by inserting a customer-specific identification into a title sequence for the movie and transmitting the movie including the customer-specific identification in the title sequence. The movie may be transmitted via cable, satellite and/or Internet transmission and/or by generating a custom copy of a videotape, DVD or other media, including the customer-specific identification in the title sequence.

Embodiments of the invention also may provide for viewing a movie by ordering the movie by a customer and receiving the movie, including a customer-specific identification in the title sequence, by the customer or the customer's designee. As was described above, viewing may be by cable, satellite, Internet and/or viewing a physical copy of the movie.

Finally, embodiments of the present invention provide a movie format that comprises a title sequence that identifies actors, directors and/or producers of the movie, a customer specific identification in the title sequence that identifies a customer who ordered the movie and a movie that corresponds to the title sequence. Movie formats according to embodiments of the invention may be distributed in pay-per-view systems via cable, satellite and/or the Internet, and/or through physical media, such as videotapes, DVDs and/or other physical media. By taking advantage of a customer's desire for recognition and/or prestige, enhanced revenues may be obtained during distribution windows.

### BRIEF DESCRIPTION OF THE DRAWINGS

FIG. 1 is a flowchart of systems and methods for distributing movies according to embodiments of the present invention.

FIG. 2 is a flowchart of systems and methods for duplicating movies according to embodiments of the present invention.

FIG. 3 is a flowchart of systems and methods for viewing movies according to embodiments of the present invention.

FIGS. 4A-4B illustrate movie formats according to embodiments of the present invention.

FIGS. 5A-5C are block diagrams of systems and methods for distributing, duplicating and/or viewing movies according to embodiments of the present invention using cable, satellite and the Internet, respectively.

FIGS. 6A-6D are screen shots of an example of a customer-specific identification in a title sequence of a movie.

FIG. 7 is a flowchart of systems and methods for inserting customer-specific identification into title sequences according to embodiments of the invention.

FIG. 8 is a flowchart of systems and methods for distributing, duplicating and/or viewing movies according to embodiments of the invention.

### DETAILED DESCRIPTION OF PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout the detailed description.

The present invention now will be described with reference to block diagrams and/or flowchart illustrations of methods and systems that can include computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagrams and/or flowchart block or blocks.

The computer program instructions may also be loaded onto a computer or other programmable data processing apparatus to cause a series of operational steps to be performed on the computer or other programmable apparatus to produce a computer implemented method or process such that the instructions which execute on the computer or other programmable apparatus provide steps for implementing the functions specified in the block diagrams and/or flowchart block or blocks. Moreover, some or all of the operational steps need not be performed on a computer or other programmable data processing apparatus, and the series of operational steps can implement methods and/or systems of doing business.

It should also be noted that in some alternative implementations, the functions noted in the blocks may occur out of the order noted in the flowcharts. For example, two blocks shown in succession may in fact be executed substantially concurrently or the blocks may sometimes be executed in the reverse order, depending upon the functionality involved.

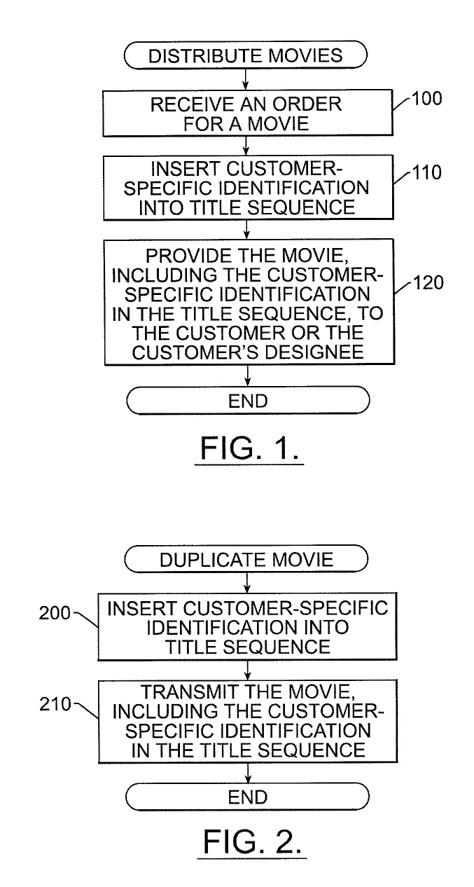

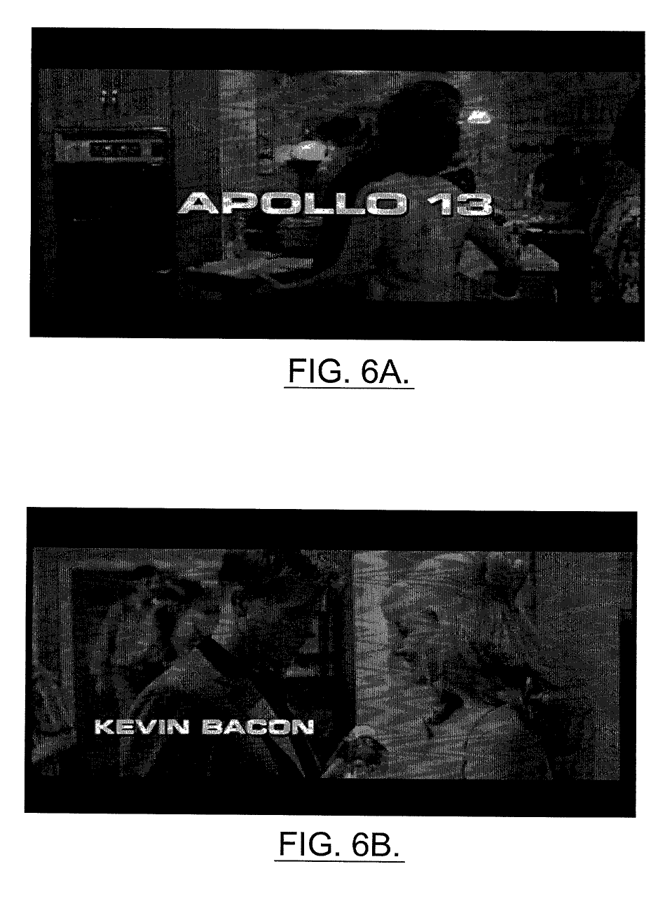

FIG. 1 is a flowchart of movie distribution according to embodiments of the present invention. At Block 100, an order is received for a movie from a customer. In some embodiments, the order is received from a customer set top box 502a that is connected to a cable television company 506 via a cable distribution system 510, as shown in FIG. 5A. In other embodiments, the order is received at a satellite television company 526 from a customer set top box 522a over a satellite distribution system 530 including a satellite 532, as shown in FIG. 5B. In still other embodiments, the order is received at a movie server 546 over the Internet 550 from a customer client 542a, which may be a personal computer, a Web TV or other Internet-connected computer, as shown in FIG. 5C. In still other embodiments, a customer may place an order from a hotel room using a conventional on-demand television with an on-demand television remote control.

In yet other embodiments, the order may be placed by a customer in a bricks-and-mortar video rental store or “media store”, where customers generally rent or purchase movies in the form of videotapes, DVDs and/or other media. Finally, in still other embodiments, an order may be placed by a customer from a personal computer that is connected to the Internet using a browser, wherein the movie is not viewed at the customer's personal computer but, rather, at some other location. The specific manner of ordering a movie by a customer and receiving an order for a movie by a movie distribution entity, such as a cable television company, a satellite television company or an Internet movie distribution company, are well known to those having skill in the art and need not be described further herein. It also will be understood that in a cable, satellite or Internet movie distribution system as shown in FIGS. 5A, 5B and 5C, respectively, the customer name and/or other identifying information generally already is known. When ordering a movie from a movie rental or media store, the customer name may be obtained from credit card information, from membership information and/or by a specific inquiry at the time of placing the order.

Referring again to FIG. 1, at Block 110 a customer-specific identification is inserted into a title sequence for the movie that identifies actors, directors and/or producers of the movie. In particular, as used herein, a title sequence includes the opening and/or closing credits of a movie. While not necessarily part of a movie story, the title sequence is nevertheless considered to be a part of the overall movie experience, similar to the musical score, lighting and other elements that comprise the movie. Originally, a sequence of title boards was filmed in order to produce a title sequence. However, presently, it is well known to use digital software to create title sequences for movies. Some titling software can be highly sophisticated, creating one-of a-kind sequences based on complex programming parameters. These title sequences may be superimposed on background video and/or audio, including parts of the plot of the movie. The title sequence generally identifies actors, directors, producers, costume designers, photographers, equipment manufacturers, locations of shooting and other information including people or entities who contributed to the movie. When a movie has been completed and delivered to distribution, the content and configuration parameters of the title sequence software generally are discarded and are not used again.

In sharp contrast, according to embodiments of the invention, as described, for example, at Block 110 of FIG. 1, a customer-specific identification is inserted into the title sequence. The customer-specific identification may be inserted into the title sequence using custom title sequence generation systems, methods and/or computer program products 508 of FIG. 5A, 528 of FIG. 5B or 548 of FIG. 5C. For example, digital title sequence software may be modified to allow retrieval of an existing title sequence, inserting the customer-specific identification, and generating a new copy of the movie including the custom title sequence, using techniques well known to those having skill in the art. The custom title sequence generating systems, methods and computer program products 508, 528 and 548 may be integrated with the cable television company 506, satellite television company 526 or movie server 546 of FIGS. 5A, 5B and 5C, respectively. Alternatively or additionally, existing entities that presently create title sequences may also be used to insert customer-specific identification into the title sequences, as described in Block 110.

Accordingly, as shown at Block 110 of FIG. 1, titling software and/or systems can integrate, including appending or prepending, arbitrary text into an existing title sequence, thereby creating a modified or custom title sequence containing new title credits including a customer-specific identification. In some embodiments, a remote network connection can activate titling software for the purpose of rendering new titling information and effectively integrating new title data into a movie for display. In other embodiments, titling software may be downloaded to a local device, such as a set top box or personal computer, which is capable of rendering new titling information and effectively integrating new title data into a movie for display.

The titles so rendered can be displayed in such a way as to appear to be part of the overall movie experience. Thus, although title sequences have been customized for broad markets by acknowledging subtitlers, foreign distributors, restoration companies or others who may create a derivative work based on a movie, these modified title sequences do not appear to have inserted customer-specific identification into a title sequence based on an order that is received from a customer. Moreover, movies have been customized for broad markets through the addition of subtitles. However, these subtitles do not appear to have inserted a customer-specific identification into a title sequence of the movie based on an order that is received from a customer. In sharp contrast, embodiments of the invention can insert a customer-specific identification into the title sequence of the movie, to thereby enhance the value of the product that is marketed to distributors and/or to the viewing public. Accordingly, a premium can be obtained for movies that are delivered to customers in certain windows and/or the number of customers who are willing to pay a premium for such movies can be increased.

Referring again to FIG. 1, at Block 120, in some embodiments, the movie, including the customer-specific identification in the title sequence, is provided to the customer who ordered the movie. In yet other embodiments, at Block 120, the movie, including the customer-specific identification in the title sequence, is provided to the customer's designee. Thus, a movie event, such as a pay-per-view movie event, may be given as a gift by the customer to a designee of the customer. Embodiments of the invention, therefore, may spawn an enhanced movie gifting industry. The movie, including the customer-specific identification in the title sequence, may be provided to the customer via the customer's cable television set top box 502a and customer's television 504a of FIG. 5A, the customer's satellite set top box 522a and the customer's television 524a of FIG. 5B, and/or the customer's Internet client device 542a and customer's television or computer monitor 544a of FIG. 5C. Alternatively, the movie, including the customer-specific identification in the title sequence, may be provided to the designee of the customer via the designee's cable television set top box 502b and television 504b in FIG. 5A, the designee's satellite television set top box 522b and television 524b of FIG. 5B, and/or the designee's Internet client device 542b and television or monitor 544b of FIG. 5C.

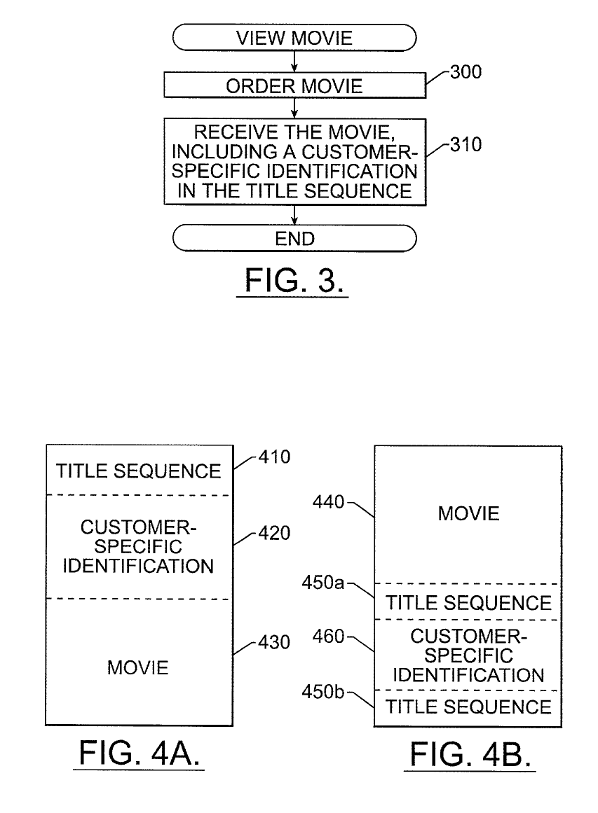

Referring now to FIG. 2, movies may be duplicated, according to embodiments of the present invention, by inserting customer-specific identification into the title sequence at Block 200. This insertion may be produced by custom title sequence generation systems, methods and/or computer program products 508 of FIG. 5A, 528 of FIG. 5B and/or 548 of FIG. 5C. The custom sequence generation systems, methods and/or computer program products 508, 528 and/or 548 may be integrated within the respective cable television company 506, satellite television company 526 or movie server 546 of FIGS. 5A, 5B and 5C, respectively. Alternatively, independent entities such as conventional title sequence software companies may provide the custom title sequence generation.

As was described above, titling software has largely replaced manual methods for inserting title credits into movies. Some titling software can be highly sophisticated, creating one-of a-kind sequences based on complex programming parameters. Heretofore, once the title sequence was completed and delivered, it generally was not changed, and the titling parameters and sometimes the software in the machines themselves used to create the titles were abandoned, not to be used again. In sharp contrast, embodiments of the present invention can create custom title sequences that incorporate a customer and/or designee identification into an existing title sequence of a movie, such that the custom title sequence can be displayed as being integral to the original movie. Thus, an existing title sequence is augmented with a customer-specific identification that is displayed as part of the overall movie display experience.

Referring again to FIG. 2 at Block 210, the movie, including the customer-specific identification in the title sequence, is transmitted, for example using a cable network 510, satellite network 530, the Internet 550 of FIGS. 5A, 5B and 5C, respectively, and/or using distribution of physical media through the mail and/or store pickup. As was described above, the movie may be transmitted back to the customer or transmitted to the customer's designee.

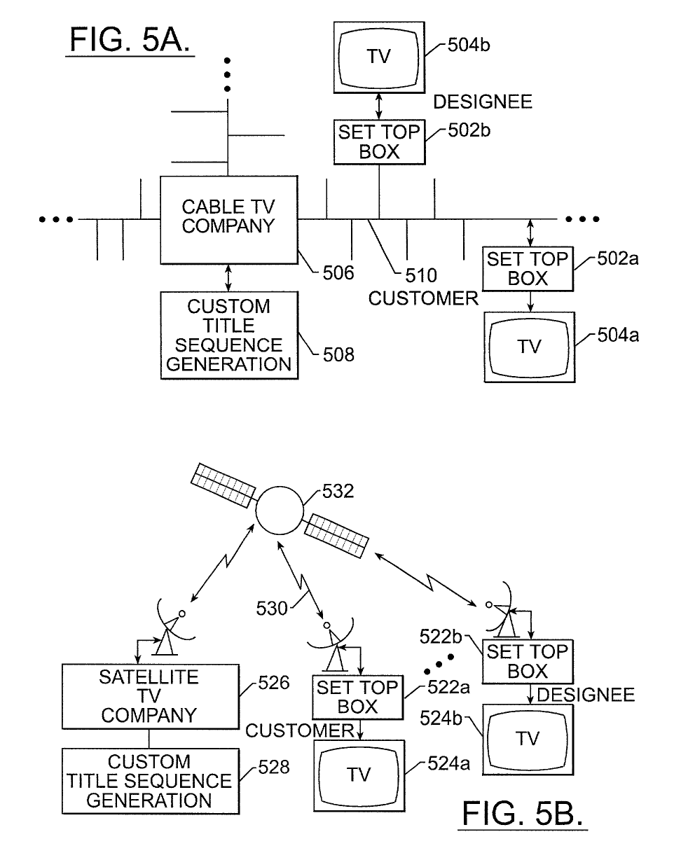

FIG. 3 is a flowchart of embodiments for viewing a movie by a customer according to embodiments of the present invention. As shown in FIG. 3 at Block 300, the movie is ordered. As was described above, the movie may be ordered via the customer's set top box 502a, 522a and/or Internet client 542a of FIGS. 5A, 5B and 5C, respectively. In these environments, since the cable, satellite or Internet system has already been set up, the customer identification already is known. Moreover, when ordering on-demand movies in a hotel, the customer identification already may be known as part of the customer check-in procedure. When ordering a movie at a movie rental or media sales store, the customer identification may be known via a required membership and/or may be obtained at a point of sale. Accordingly, embodiments of the invention can integrate systems that contain authentication and authorization information with title generation systems and methods, such that personalized titles can be delivered as an integral part of a movie experience.

Referring again to FIG. 3, at Block 310, the movie, including a customer-specific identification in the title sequence, is received at the customer location, for example at the set top box 502a, 522a, Internet client 542a of FIGS. 5A, 5B and 5C. The movie, including the customer-specific identification in the title sequence, may be viewed at the television/monitor 504a, 524a, 544a of FIGS. 5A, 5B and 5C, respectively.

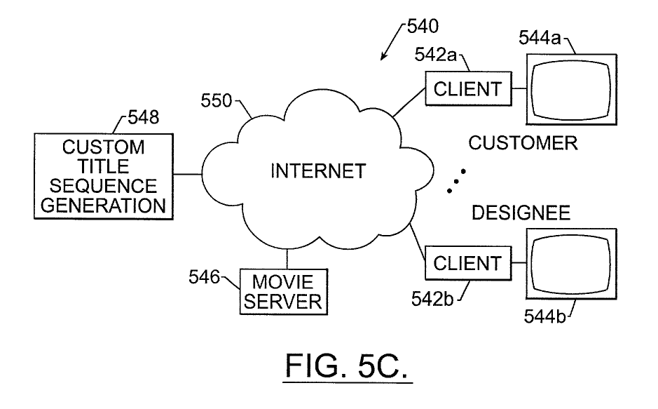

FIGS. 4A and 4B illustrate examples of movie formats according to embodiments of the present invention. As shown in FIG. 4A, embodiments of a movie format include a title sequence 410 that identifies actors, directors and/or producers of the movie. Movie title sequences have been part of movies since the beginning of the industry. Movie title sequences serve to recognize those who contributed talent, time and/or resources to the production and/or distribution of the movie. It is well known in the movie production and distribution industries that recognition, in the form of a movie title credit, is valued by those who are credited. In fact, a title credit often is a material consideration offered to secure a party's participation in the development, production and/or distribution of a movie.

Continuing with the description of FIG. 4A, the movie format also includes a customer-specific identification 420 that is integrated in the title sequence, and with the movie 430 itself. Thus, dashed lines are shown between the title sequence 410, the customer-specific identification 420 and the movie 430, to indicate that the title sequence, customer-specific identification and movie may be integrated into a seamless whole. The movie format may be provided in a single pay-per-view transmission and/or in a single physical medium such as a videocassette and/or DVD.

FIG. 4B illustrates other movie formats according to embodiments of the invention, wherein the title sequence is placed after the movie 440 and is divided into two title sequence segments 450a and 450b with the customer-specific identification 460 therebetween. It also will be understood that the title sequence also may occur both at the beginning and at the end of the movie. Customer-specific identification according to embodiments of the invention may be placed in a title sequence at the beginning and/or at the end of a movie. Accordingly, the entertainment content may be customized to acknowledge the customer in the title credits.

Many different embodiments of customer-specific identification may be provided that may only be limited by the imagination of the motion picture production and distribution industry, and by customers' desires. In some embodiments, the name of the customer or the name the designee may be inserted in the sequential listing of names of actors, directors and/or producers of the movie. In other embodiments, the words “screened by” followed by the name of the customer may be inserted into the title sequence. In other embodiments, the words “brought to you by” followed by the name of the customer may be inserted into the title sequence. The words “brought to you by” followed by the name of the customer, may be used when the movie is provided to the customer, for example when the customer will be screening the movie in a home theater to a group of friends. The words “brought to you by” followed by the name of the customer also may be used when the movie is provided to the customer's designee when the customer has gifted the movie viewing for a designee. In yet other embodiments, the customer-specific identification comprises the words “screened for” followed by the name of the designee of the customer, followed by the word “by” followed by the name of the customer. Thus, gifting of movies is facilitated.

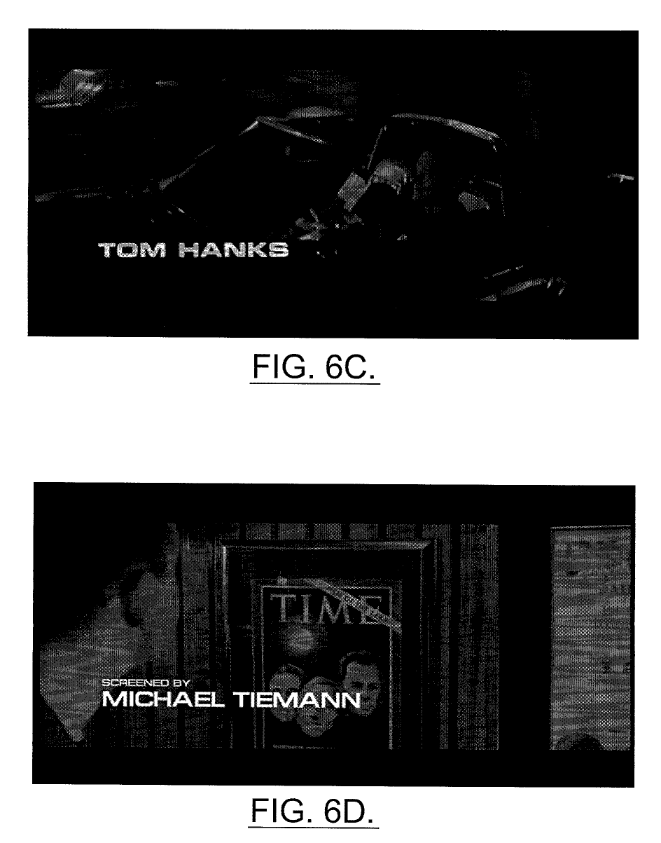

FIGS. 6A-6D are screen shots of four successive frames in a title sequence that illustrates insertion of customer-specific identification in the title sequence, according to embodiments of the present invention. FIGS. 6A-6D are an example from the movie “Apollo 13”. FIGS. 6A-6C are actual screen shots from the title sequence, illustrating the title and two actors, respectively. FIG. 6D illustrates the name of a customer as a form of customer-specific identification that is inserted according to embodiments of the present invention. Many other formats and insertions of customer-specific identification may be provided according to embodiments of the present invention.

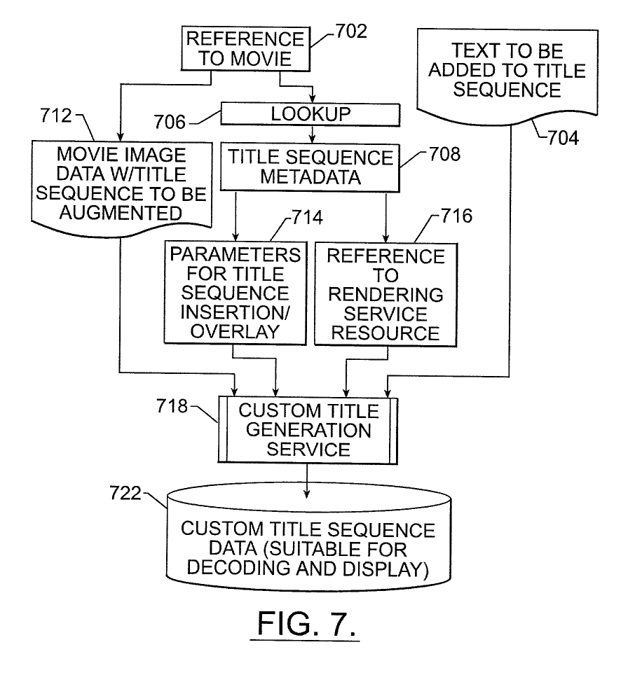

FIG. 7 is a flowchart illustrating detailed operations for inserting customer-specific identification into title sequences according to embodiments of the present invention, which may be used, for example, in Block 110 of FIG. 1 and Block 200 of FIG. 2. As shown in FIG. 7, when a user orders a movie (for example, Block 300 of FIG. 3), and an order for a movie is received (for example, Block 100 of FIG. 1), a reference to the movie that was ordered is obtained at Block 702, and the customer-specific identification text to the added to the title sequence also is obtained at Block 704. The reference at Block 702 is used at Block 706 to look up title sequence metadata at Block 708. The title sequence metadata at Block 708 includes parameters 714 for title sequence insertion and/or overlay, and also can include a reference to the rendering service resource at Block 716. A custom title generation service 718, which may correspond to the custom title generation Block 508 of FIG. 5A, Block 528 of FIG. 5B and/or Block 548 of FIG. 5C, uses the movie image data with the title sequence to be augmented at Block 712, the parameters at Block 714, the reference at Block 716 and the text at Block 704, to create custom title sequence data at Block 722 that is suitable to decoding and display. As was described above, the custom title generation service (Block 718) may be separate from or part of the distribution channel company.

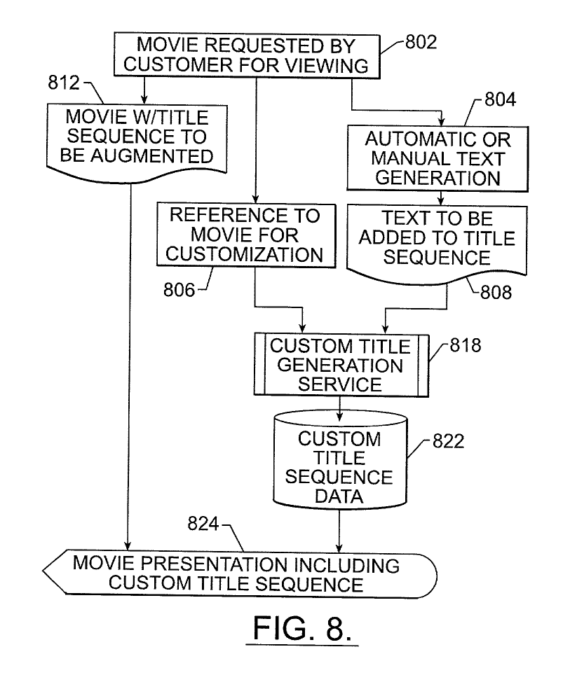

FIG. 8 illustrates other embodiments of systems and methods for distributing, duplicating and/or viewing movies according to embodiments of the invention. As shown in FIG. 8, these embodiments begin when a movie is requested by a customer for viewing at Block 802. This request may correspond to receiving an order for a movie at Block 100 of FIG. 1 or ordering a movie 300 of FIG. 3, and need not be described again in detail. As part of the request, automatic or manual text generation may be performed at Block 804 using, for example, preexisting customer identification information and/or information supplied by a customer to identify the customer and/or the designee of the customer. The movie with the title sequence to be augmented also is obtained at Block 812. A reference also is obtained to the movie for customization at Block 806. Then, at Block 818, a custom title generation service, which may correspond to Blocks 508, 528 or 548 of FIGS. 5A, 5B and 5C, respectively, uses the reference to the movie for customization at Block 806 and the text to be added to the side title sequence at Block 808, to generate a custom title sequence data at Block 822. The custom title sequence data 822 is then integrated with the movie, so that at Block 824, the movie is presented including the custom title sequence. The operations of Block 824 may correspond to the operations of Blocks 120, 210 and 310 of FIGS. 1, 2 and 3, respectively, and need not be described again.

Actors, directors and/or producers of a movie have often gone to extreme lengths to get their name in a title credit. The opening title credit generally is the most prestigious placement a movie has to offer. According to embodiments of the invention, a customer can screen a new film for the customer's friends in the customer's home theater, and the friends can see the customer's name seamlessly integrated into the title sequence. It appears that Hollywood is giving the customer recognition, and the customer and friends see the customer's name sharing top billing with the stars, producers and/or directors. Thus, pay-per-view and other movie distributors may now monetize people's desire for prestige and may increase the revenue they can obtain in the pay-per-view or other windows. New opportunities may be created for title sequence generating companies, as well as new gifting opportunities for movies.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of distributing movies comprising:
receiving an order for a movie from a customer;
inserting a customer-specific identification into a title sequence for the movie that identifies actors, directors and/or producers of the movie; and
providing the movie, including the customer-specific identification in the title sequence, to the customer or a designee of the customer.

2. A method according to claim 1 wherein the receiving comprises receiving an order for the movie from the customer over a cable television system, and wherein the providing comprises providing the movie, including the customer-specific identification in the title sequence, to the customer or the designee of the customer, over the cable television system.

3. A method according to claim 1 wherein the receiving comprises receiving an order for the movie from the customer over a satellite television system, and wherein the providing comprises providing the movie, including the customer-specific identification in the title sequence, to the customer or the designee of the customer, over the satellite television system.

4. A method according to claim 1 wherein the receiving comprises receiving an order for the movie from the customer over the Internet, and wherein the providing comprises providing the movie, including the customer-specific identification in the title sequence, to the customer or the designee of the customer, over the Internet.

5. A method according to claim 1 wherein the title sequence is a digital title sequence and wherein the inserting comprises digitally inserting the customer-specific identification into the digital title sequence.

6. A method according to claim 1 wherein the title sequence includes a sequential listing of names of actors, directors and/or producers of the movie and wherein the customer specific identification comprises the name of the customer or designee in the sequential listing of names of actors, directors and/or producers of the movie.

7. A method according to claim 1 wherein the customer-specific identification comprises the words “screened by” followed by the name of the customer.

8. A method according to claim 1 wherein the customer-specific identification comprises the words “brought to you by” followed by the name of the customer.

9. A method according to claim 1 wherein the customer-specific identification comprises the words “screened for” followed by the name of the designee of the customer, followed by the word “by”, followed by the name of the customer.

10. A method according to claim 1 wherein the providing comprises:
generating a copy of the movie, including the customer-specific identification in the title sequence, on a physical medium; and
delivering the physical medium to the customer or the designee of the customer.

11. A method of duplicating movies comprising:
inserting a customer-specific identification into a title sequence for the movie that identifies actors, directors and/or producers of the movie; and
transmitting the movie including the customer-specific identification in the title sequence.

12. A method according to claim 11 wherein the transmitting comprises transmitting the movie, including the customer-specific identification in the title sequence, to the customer or a designee of the customer, over a cable television system, a satellite television system and/or the Internet.

13. A method according to claim 11 wherein the title sequence is a digital title sequence and wherein the inserting comprises digitally inserting the customer-specific identification into the digital title sequence.

14. A method according to claim 11 wherein the title sequence includes a sequential listing of names of actors, directors and/or producers of the movie and wherein the customer specific identification comprises the name of the customer or a designee of the customer in the sequential listing of names of actors, directors and/or producers of the movie.

15. A method according to claim 11 wherein the customer-specific identification comprises the words “screened by” followed by the name of the customer.

16. A method according to claim 11 wherein the customer-specific identification comprises the words “brought to you by” followed by the name of the customer.

17. A method according to claim 11 wherein the customer-specific identification comprises the words “screened for” followed by the name of a designee of the customer, followed by the word “by”, followed by the name of the customer.

18. A method according to claim 11 wherein the transmitting comprises:
generating a copy of the movie, including the customer-specific identification in the title sequence, on a physical medium; and
providing the physical medium to the customer or a designee of the customer.

19. A method of viewing a movie comprising:
ordering the movie by a customer; and
receiving the movie, including a customer-specific identification in a title sequence for the movie that identifies actors, directors and/or producers of the movie, by the customer or by a designee of the customer.

20. A method according to claim 19 wherein the ordering comprises ordering the movie by the customer over a cable television system, and wherein the receiving comprises receiving the movie, including the customer-specific identification in the title sequence, by the customer or by the designee of the customer, over the cable television system.

21. A method according to claim 19 wherein the ordering comprises ordering the movie by the customer over a satellite television system, and wherein the receiving comprises receiving the movie, including the customer-specific identification in the title sequence, by the customer or by the designee of the customer, over the satellite television system.

22. A method according to claim 19 wherein the ordering comprises ordering the movie by the customer over the Internet, and wherein the receiving comprises receiving the movie, including the customer-specific identification in the title sequence, by the customer or by the designee of the customer, over the Internet.

23. A method according to claim 19 wherein the title sequence includes a sequential listing of names of actors, directors and/or producers of the movie and wherein the customer specific identification comprises the name of the customer in the sequential listing of names of actors, directors and/or producers of the movie.

24. A method according to claim 19 wherein the customer-specific identification comprises the words “screened by” followed by the name of the customer.

25. A method according to claim 19 wherein the customer-specific identification comprises the words “brought to you by” followed by the name of the customer.

26. A method according to claim 19 wherein the customer-specific identification comprises the words “screened for” followed by the name of the designee of the customer, followed by the word “by”, followed by the name of the customer.

27. A method according to claim 19 wherein the receiving comprises:
receiving a copy of the movie, including the customer-specific identification in the title sequence, on a physical medium, by the customer or by the designee of the customer.

28. A movie format comprising:
a title sequence that identifies actors, directors and/or producers of the movie;
a customer-specific identification in the title sequence that identifies a customer who ordered the movie; and
a movie that corresponds to the title sequence.

29. A movie format according to claim 28 wherein the title sequence includes a sequential listing of names of actors, directors and/or producers of the movie and wherein the customer specific identification comprises the name of the customer in the sequential listing of names of actors, directors and/or producers of the movie.

30. A movie format according to claim 28 wherein the customer-specific identification comprises the words “screened by” followed by the name of the customer.

31. A movie format according to claim 28 wherein the customer-specific identification comprises the words “brought to you by” followed by the name of the customer.

32. A movie format according to claim 28 wherein the customer-specific identification comprises the words “screened for” followed by the name of a designee of the customer, followed by the word “by”, followed by the name of the customer.

33. A movie format according to claim 28 wherein the title sequence and the customer-specific identification precede the movie.

34. A movie format according to claim 28 wherein the title sequence and the customer-specific identification follow the movie.

35. A movie format according to claim 28 wherein the title sequence precedes and follows the movie and the customer-specific identification precedes the movie.

36. A movie format according to claim 28 wherein the title sequence precedes and follows the movie and the customer-specific identification follows the movie.

37. A movie format according to claim 28 wherein the title sequence includes background video and audio and wherein the customer-specific identification also includes the background video and audio.

38. A movie format according to claim 28 wherein a single copy of the title sequence, the customer-specific identification and the movie are included in a single physical medium.

39. A movie format according to claim 28 wherein a single copy of the title sequence, the customer-specific identification and the movie are transmitted via a cable television system, a satellite television system and/or the Internet.

40. A system for distributing movies comprising:
means for receiving an order for a movie from a customer;
means for inserting a customer-specific identification into a title sequence for the movie that identifies actors, directors and/or producers of the movie; and
means for providing the movie, including the customer-specific identification in the title sequence, to the customer or a designee of the customer.

41. A system according to claim 40 wherein the means for receiving comprises a cable television company, and wherein the means for providing comprises a cable television set top box.

42. A system according to claim 40 wherein the means for receiving comprises a satellite television company, and wherein the means for providing comprises a satellite television set top box.

43. A system according to claim 40 wherein the means for receiving comprises an Internet movie server, and wherein the means for providing comprises an Internet client.

44. A system according to claim 40 wherein the means for inserting comprises digital title insertion software.

45. A system according to claim 40 wherein the title sequence includes a sequential listing of names of actors, directors and/or producers of the movie and wherein the customer specific identification comprises the name of the customer or the designee of the customer in the sequential listing of names of actors, directors and/or producers of the movie.

46. A system according to claim 40 wherein the customer-specific identification comprises the words “screened by” followed by the name of the customer.

47. A system according to claim 40 wherein the customer-specific identification comprises the words “brought to you by” followed by the name of the customer.

48. A system according to claim 40 wherein the customer-specific identification comprises the words “screened for” followed by the name of the designee of the customer, followed by the word “by”, followed by the name of the customer.

49. A system according to claim 40 wherein the means for providing comprises:
means for generating a copy of the movie, including the customer-specific identification in the title sequence, in a physical medium; and
means for delivering the physical medium to the customer or the designee of the customer.

50. A system for duplicating movies comprising:
means for inserting a customer-specific identification into a title sequence for the movie that identifies actors, directors and/or producers of the movie; and
means for transmitting the movie including the customer-specific identification in the title sequence.

51. A system according to claim 50 wherein the means for transmitting comprises means for transmitting the movie, including the customer-specific identification in the title sequence, to the customer or a designee of the customer, over a cable television system, a satellite television system and/or the Internet.

52. A system according to claim 50 wherein the means for inserting comprises digital title insertion software.

53. A system according to claim 50 wherein the title sequence includes a sequential listing of names of actors, directors and/or producers of the movie and wherein the customer specific identification comprises the name of the customer or a designee of the customer in the sequential listing of names of actors, directors and/or producers of the movie.

54. A system according to claim 50 wherein the customer-specific identification comprises the words “screened by” followed by the name of the customer.

55. A system according to claim 50 wherein the customer-specific identification comprises the words “brought to you by” followed by the name of the customer.

56. A system according to claim 50 wherein the customer-specific identification comprises the words “screened for” followed by the name of a designee of the customer, followed by the word “by”, followed by the name of the customer.

57. A system according to claim 50 wherein the means for transmitting comprises:
means for generating a copy of the movie, including the customer-specific identification in the title sequence, in a physical medium; and
means for providing the physical medium to the customer or a designee of the customer.

58. A system for viewing a movie comprising:
means for ordering the movie by a customer; and
means for receiving the movie, including a customer-specific identification in a title sequence for the movie that identifies actors, directors and/or producers of the movie, by the customer or by a designee of the customer.

59. A system according to claim 58 wherein the means for ordering and the means for receiving comprise a cable television set top box.

60. A system according to claim 58 wherein the means for ordering and the means for receiving comprise a satellite television set top box.

61. A system according to claim 58 wherein the means for ordering and the means for receiving comprise an Internet client.

62. A system according to claim 58 wherein the title sequence includes a sequential listing of names of actors, directors and/or producers of the movie and wherein the customer specific identification comprises the name of the customer in the sequential listing of names of actors, directors and/or producers of the movie.

63. A system according to claim 58 wherein the customer-specific identification comprises the words “screened by” followed by the name of the customer.

64. A system according to claim 58 wherein the customer-specific identification comprises the words “brought to you by” followed by the name of the customer.

65. A system according to claim 58 wherein the customer-specific identification comprises the words “screened for” followed by the name of the designee of the customer, followed by the word “by”, followed by the name of the customer.

66. A system according to claim 58 wherein the receiving comprises:
receiving a copy of the movie, including the customer-specific identification in the title sequence, in a physical medium, by the customer or by the designee of the customer.
